(19) United States
(12) Patent Application Publication
(10) Pub. No.: US 2003/0226680 A1
(43) Pub. Date: Dec. 11, 2003

(54) Cable gland assemblies

(76) Inventor: Carl Jackson, Dukinfield (GB)

Correspondence Address: CARR LAW FIRM, L.L.P., 670 FOUNDERS SQUARE, 900 JACKSON STREET, DALLAS, TX, 75202, US

(21) Appl. No.: 10/164,667

(22) Filed: Jun. 7, 2002

(51) Int. Cl. H02G 3/06

(52) U.S. Cl. 174/65 SS

(57) ABSTRACT

A cable gland assembly to provide a mechanical and electrical connection between a cable and a wall. The assembly including an earthing tag, the tag having an aperture to receive a part of the cable gland assembly and means to prevent rotation of the tag during tightening of the assembly to the wall.

### TECHNICAL FIELD OF THE INVENTION

The invention relates to cable gland assemblies, and particularly to the earthing of cable gland assemblies. The invention also relates to an earth tag for cable gland assemblies.

### BACKGROUND OF THE INVENTION

Cable gland assemblies typically provide a seal and a mechanical and/or an electrical connection between a cable and a wall through which the cable passes. A cable gland assembly may comprise a seal, which is clamped between an adaptor and the wall, so that the seal is forced radially of an aperture into sealing contact with the assembly. The clamping on fastening the assembly may also bring the adaptor into contact with a tag, thereby providing an electrical connection from the assembly to earth.

A problem with cable gland assemblies of this type is that the tag may be urged to rotate on fastening the assembly as a result of the relative rotating motion which is involved. The rotation of the tag may result in its misplacement and hinder its installation, not least because several assemblies are often installed in close proximity and the tag needs to maintain its position in order not to interfere with other, adjacent assemblies and for easy attachment of an earth connection.

### SUMMARY OF THE INVENTION

Disclosed herein is a cable gland assembly comprising parts providing a mechanical and/or electrical connection between a cable and a wall, and a tag which is fastened by clamping between a part of the assembly and another part of the assembly or the wall thereby to provide a connection to earth from the assembly, wherein the tag comprises a means for opposing rotation of the tag about a part of the assembly during clamping.

### BRIEF DESCRIPTION OF THE DRAWINGS

For a more complete understanding of the present invention and the advantages thereof, reference is now made to the following description taken in conjunction with the accompanying drawings, in which:

FIG. 1 is a partial cross sectional view of a cable gland assembly according to an embodiment of the invention; and

FIG. 2 is a perspective view of an earth tag for an assembly according to the invention.

### DETAILED DESCRIPTION

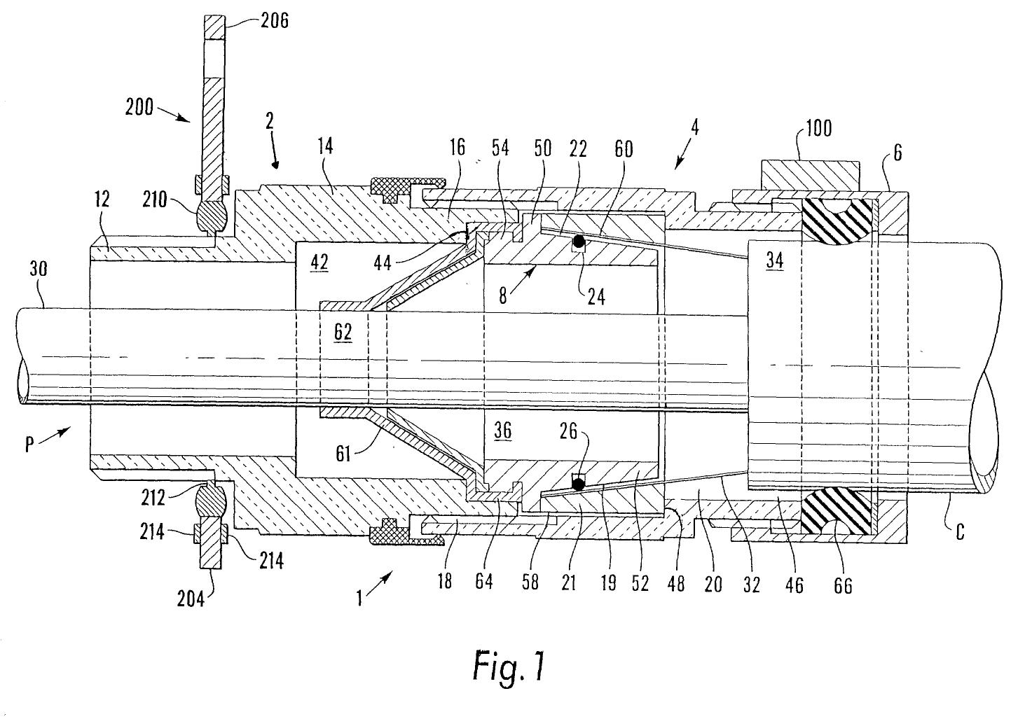

With reference to FIG. 1, a cable gland assembly indicated generally at 1 consists essentially of four parts: an adaptor 2, a sleeve 4, a cap nut 6, all preferably made from brass, and a clamping arrangement 8. The four generally cylindrical parts 2, 4, 6, 8 together define a central passageway P for a cable C and are preferably formed of a conducting material such as a metal, preferably being brass.

The adaptor 2 has a radially extending flange 14 which is partly hexagonally shaped for a spanner. To one side of the flange 14 the adaptor 2 has an externally threaded entry portion 12 for insertion through a hole in the wall of, say, a junction box (not shown). The adaptor 2 may be fastened to the wall with a nut (not shown) screwed on to the entry portion 12 after insertion. To the other side of the flange 14, the adaptor 2 has an externally threaded attachment portion 16, which is preferably of larger diameter than the entry portion 12. The adaptor 2 has a multiple-stepped bore 42, which gradually decreases in diameter towards the entry portion end, and the step nearest the attachment portion end provides a shoulder 44. A rubber diaphragm seal 61 with a central opening 62 capable of expanding to accommodate various different diameters of cable has an annular retaining ring 64 which is seated against the shoulder 44.

The sleeve 4 has at one end an internal thread 18 for engagement with the thread on the attachment portion 16 of the adaptor 2. At its opposite end 20, the sleeve 4 is externally threaded to receive the cap nut 6. The sleeve 4 has a bore 46 with a step approximately at its midpoint which provides a shoulder 48.

The clamping arrangement 8 comprises first and second clamping parts 19, 21, which together define a cable armour clamping gap 22 therebetween. Extending into the gap 22 from an annular recess 24 in the first clamping part is cable armour engaging means 26.

The cable C comprises inner conducting wires (not shown) surrounded sequentially by an inner insulating sheath 30, armour wires 32 and an outer insulating sheath 34. The armour wires 32 are exposed as a result of the stripping back of the outer insulating sheath 34, which needs to extend only sufficiently into the passageway P to establish a seal.

The first clamping part 19 is constituted by a spigot having a central bore 36 of a size greater than the diameter of the cable C in the region where it has been stripped back. The spigot 19 is divided by a radially extending flange 50 into a clamping portion 52 of frusto-conical shape and a substantially cylindrical sealing portion 54, which is a close tolerance fit in the retaining ring 64 of the seal 61.

The second clamping part 21 is constituted by a clamping ring having a cylindrical outer surface 58 and a central bore, which is tapered in a manner complimentary to the shape of the clamping portion 52 of the spigot 19, but of larger diameter. As a result, when the spigot 19 and the clamping ring 56 are fitted together, the interior surface 60 of the clamping ring 21 and the exterior surface of the clamping portion 52 have a substantially parallel relationship. The clamping ring 21 is a close tolerance fit in the bore 46 of the sleeve 4, abutting against the shoulder 48.

The cable armour clamping means 26 is constituted by a resiliently compliant split, metal o-ring received in the annular recess 24. In its normal state, the o-ring 26 is of such a diameter that it will extend out of the recess 24 and into the gap 22, but is capable of complying, that is, compressing, in terms of its diameter decreasing, to the extent that it can recede completely into the recess 24 and no part of it any longer extends into the gap 22. The o-ring 26 is resilient in that its reaction to compression is to attempt to return to its normal state diameter.

The effect of screwing the sleeve 4 and the adaptor 2 together is to urge the clamping ring 21 axially towards the spigot 19 thereby to close the clamping gap 22 and to clamp the armour wires 32 between the spigot 19 and the clamping ring 21. The split o-ring 26 will compress according to the thickness of the wires 32, and its reaction to compressing will be to exert a clamping force on the wires 32. The wires 32 may be of such a thickness that a suitable clamping gap is attained before the axially forward end of the clamping ring 21 reaches the flange 50 of the spigot 19, in which case the o-ring 26 will comply to the extent of receding completely into the recess 24. On the other hand, and as specifically shown in FIG. 1, the wires 32 may be thinner than even the minimum clamping gap attainable (determined by the relative dimensions of the spigot 19 and the clamping ring 21), in which case, the o-ring 26 is compressed only sufficiently to permit the accommodation of the wire 32, and the reaction force the o-ring 26 exerts clamps the wires 32 against the clamping ring 21.

An annular seal 66 is disposed between the cap nut 6 and the sleeve 4, and the effect of screwing the cap nut 6 on to the sleeve 4 is to radially compress the seal 66 against the cable C.

Fixed to the outer surface of the cap nut 6, with high performance adhesive, is a generally disc-shaped transponder 100. Suitable transponders are manufactured by the AEG company under their designations ID300 and ID700. The transponder 100 has an information storage facility (not shown) for storing information, such as a unique identity code for the assembly, data relevant to its last inspection, etc. Typically, the transponder 100 is capable of storing eighty bits of information. The information may be read from the storage facility.

The information storage facility of the transponder 100 is divided into two portions. A first portion containing a unique code for the assembly 1 including identification of its type, model number, cable size acceptance, certification references (that is, the standards which it is certified to fulfil) and performance limits. This information is hand written into the first portion at about the time the transponder 100 is incorporated into the assembly and may not easily be erased or altered, at least, not in the field. The second portion of the storage facility is field programmable to facilitate the storage in the memory of information such as inspection status, last inspection date and site reference, which needs to be updated periodically.

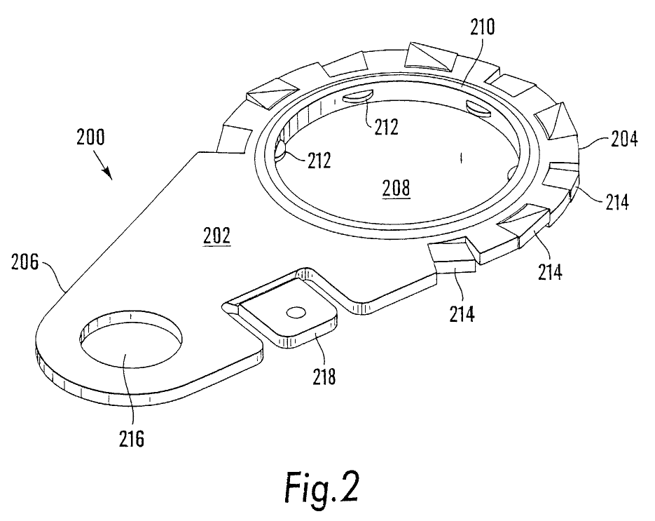

With reference also to FIG. 2, an earth tag 200 preferably comprises a substantially laminar body 202 having an apertured portion 204 and an outwardly extending portion 206. The apertured portion 204 preferably has an aperture 208 for receiving a part of the cable gland assembly 1.

Additionally, the tag preferably comprises a means for sealing between the body of the tag and a part or parts of the assembly or the wall. The sealing means preferably comprise a sealing ring 210 located in the aperture 208. The sealing ring 210 may be provided with means for holding the tag on an assembly part prior to clamping. The holding means preferably comprise a plurality of captivating protrusions 212 distributed around the radially inner face of the sealing ring. The sealing means preferably lie radially inwardly of the means for opposing rotation. Thus, on clamping, the means for opposing rotation do not cut or impair the sealing action of the sealing means. The sealing means may be a separate shaped seal ring 212 inserted into or about the tag aperture or may be moulded thereabout so as to be bonded to the tag aperture. The assembly preferably further comprises means for the attachment of an earthing connection.

The tag 200 preferably comprises a means for opposing rotation about a part of the assembly during clamping. The means for opposing rotation preferably comprises one or more tabs 214 distributed around the aperture. Preferably, a plurality of tabs 214 are distributed around the apertured portion 204, except the region where the apertured portion 204 adjoins the outwardly extending portion 206.

Each tab 214 is preferably formed by separating a rectangular piece of the apertured portion 204 on three sides from the remainder of the apertured portion 204. Alternatively, the tabs 214 may be other shapes such as triangular, or any other shape which enables them to serve their purpose of opposing rotation of the tag 200. Each tab 214 is then preferably bent at its remaining, uncut side, so as to be inclined at an angle with respect to the remainder of the body of the apertured portion 204 and to project laterally of the tag 200. The tabs 214 preferably are alternately bent, so that each tab 214 projects in the opposite lateral direction to each adjacent tab 214. Alternatively, the tabs may be configured and bent so as to extend radially with respect to the apertured portion 204.

The projections may be resiliently urged away from the tag, for instance spring loaded, or made from a compressible material whether resiliently compressible or not. Preferably, each projection comprises a tab-like piece of the tag body, which is angled to project laterally of the tag. Further preferably, each tab-like piece is resiliently urged laterally of the tag. The tag may be provided with means for holding the tag on an assembly part prior to clamping.

The outwardly extending portion 206 is preferably provided with a hole 216 for receiving an earthed bolt (not shown) and a shaped part 218 for providing a ‘fast-on’ earthed tab as an alternative.

The cable gland assembly 1 is supplied with the earth tag pre-installed. That is to say, the insertion portion 12 of the adaptor 2 is inserted through the aperture 208, and the captivating protrusions 212, which are sized to engage the insertion portion 12, hold the tag 200 on the assembly 1 and prevent it from sliding off the adaptor 2 prior to installation of the assembly 1.

On installation of the assembly 1, the earth tag 200 is preferably clamped between a wall (not shown), through which the insertion portion 12 is inserted, and the flange 14. On tightening the assembly 1, which, as aforementioned, involves screwing together the assembly 1 and a nut on the remote side of the wall, the tag 200 is squeezed between the wall and the flange 14, respectively. The first parts of the tag 200 to contact the wall and the flange 14, respectively, are the tabs 214.

As a result of being bent, the tabs 214 are preferably resiliently urged in the direction of the wall and the flange 14, which preferably promotes a good electrical connection between the wall, the assembly 1 and the tag 200. However, because the urging is resilient in nature, further tightening of the assembly simply forces the tabs 214 back towards a position at which they are co-planar with the remainder of the body of the tag 200. Tightening the assembly 1 also causes the sealing ring 210 to perform in the manner described in GB-A-2116784, the complete content of which is incorporated herein by reference.

The relative rotating motion involved in fastening the assembly 1 to the wall tends to urge the tag 200 to rotate. However, the contact between the tabs 214 and the wall and the flange 14, respectively, generates frictional forces which oppose the tendency to rotate, hence the tag 200 maintains its position. The frictional forces are maximized by arranging each tab with its longitudinal axis, that is the axis extending through the bent side and the opposite side, tangential to the aperture, so that the full length of the opposite side's edge interfaces with the flange 14 or wall, as appropriate.

The tag 200 of the cable gland assembly 1 may provide a single item which fulfils the functions of: providing an efficient earth for the assembly due to the means for opposing rotations; providing a fluid seal between the gland assembly and the wall aperture, for example, through which it passes; and, providing means to prevent rotation of the tag and ensure correct positioning. The means for preventing rotation of the tag may also fulfil the function of a so-called ‘shake-proof’ washer, keeping the gland assembly tightly clamped together and guarding against loosening of the assembly due to vibration, for example. Thus, additional shake-proof washers are not needed, making the gland assembly simpler and more compact.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A cable gland assembly comprising:
A tag which is fastened by clamping between a first part of said assembly and one of either a second part of said assembly or a wall, wherein the tag is electrically coupled to the assembly and configured to be electrically coupled to a ground, and wherein the tag comprises a means for opposing rotation of the tag about a part of the assembly during clamping.

2. The cable gland assembly of claim 1 wherein the means for opposing rotation comprises one or more tab-like projections distributed around or partly around an aperture defined in the tag.

3. The cable gland assembly of claim 2 wherein each projection is resiliently urged laterally of the tag.

4. The cable gland assembly of claim 1 wherein the tag is provided with means for holding the tag on a part of the assembly prior to clamping.

5. The cable gland assembly of claim 1 wherein the tag is provided with means for sealing between the tag and a part or parts of the assembly or the wall.

6. The cable gland assembly of claim 5 wherein the sealing means comprises a sealing ring located in the aperture.

7. The cable gland assembly of claim 6 wherein said sealing ring has a groove in which an edge of said aperture is located.

8. The cable gland assembly of claim 6 or claim 7 wherein the sealing ring is provided with means for holding the tag on a part of the assembly prior to clamping.

9. The cable gland assembly of claim 8 wherein the holding means comprise a plurality of generally curved projections distributed around a radially inner face of said sealing ring.

10. The cable gland assembly of claim 2 wherein said tab-like projections for opposing rotation promote an electrical connection between the assembly and the tag.

11. An earthing tag for a cable gland assembly comprising:
A means for opposing rotation of the tag about a part of the assembly during clamping, wherein the tag is configured to be fastened by clamping between a first part of a cable gland assembly and one of either a second part of said assembly or a wall.

12. The earthing tag of claim 11 further comprising a means for electrically coupling the assembly to earth.

13. The earthing tag of claim 11 wherein the means for opposing rotation comprises one or more tab-like projections distributed around or partly around the aperture.

14. The earthing tag of claim 13 wherein each projection is resiliently urged laterally of the tag.
